(19) United States
(12) Patent Application Publication
(10) Pub. No.: US 2011/0293868 A1
(43) Pub. Date: Dec. 1, 2011

(54) THERMOPLASTIC POLYAMIDE MOULDING COMPOSITIONS

(75) Inventors: GEORG STOEPPELMANN, BONADUZ (CH); RALPH KETTL, PASPELS (CH); PAUL SCHWITTER, SCHAENIS (CH)

(73) Assignee: EMS-CHEMIE AG, DOMATE/EMS (CH)

(21) Appl. No.: 13/208,708

(22) Filed: Aug. 12, 2011

Related U.S. Application Data
(62) Division of application No. 11/124,015, filed on May 6, 2005.

(30) Foreign Application Priority Data
May 10, 2004 (DE) 10 2004 022 963.5

(51) Int. Cl. C08K 5/3472; B32B 1/08; B29C 47/00; C08K 5/3415

(52) U.S. Cl. 428/36.9; 524/106; 524/104; 264/328.1; 264/209.1; 264/176.1

(57) ABSTRACT

The invention relates to thermoplastic polyamide moulding compositions containing: (A) at least 20% by wt. polyamide and/or at least one copolymer containing at least 20% by wt. polyamide structural units; (B) 0.01% by wt. to 2% by wt., relative to the polyamide portion and/or the portion of polyamide structural units, of the composition of a copper-containing stabiliser; and (C) 0.01% by wt. to 3% by wt., relative to the polyamide portion and/or the portion of polyamide structural units of the composition, of at least one organic compound containing metal complexing groups, so that the copper ions are present in complexed form through binding to the metal-complexing groups. These moulding compositions may be used as coating material for coolant lines.

### CROSS-REFERENCE TO RELATED APPLICATION

This application is a divisional application of and claims the priority benefit of U.S. application Ser. No. 11/124,015, filed on May 6, 2005, now pending, which claims the priority benefit of German Patent Application No. 10 2004 022 963.5, filed on May 10, 2004. The entirety of each of the above-mentioned patent applications is hereby incorporated by reference herein and made a part of this specification.

### 1. BACKGROUND OF THE INVENTION

The present invention relates to thermoplastic polyamide moulding compositions.

The present invention relates in particular to copper-stabilised thermoplastic polyamide moulding compositions with metal deactivator, which exhibit an excess of amino end groups in a preferred embodiment. These moulding compositions can be used for coating coolant lines.

The present invention relates in particular to a single- or multi-layered coolant line for the transport of cooling agents, which is particularly stable against the application-related environmental influences and increased temperatures. Cooling agents which flow through the aforementioned lines can contain, for example, antifreeze compositions of ethylene glycol, diethylene glycol, or propylene glycol and water.

Such coolant lines can have a cylindrical lateral surface and/or be corrugated, at least in parts.

The coolant lines according to the invention can be used in the overall cooling systems of automobiles, i.e. for coolant lines, heating lines, and vent lines.

Numerous systems are known for the stabilisation of polyamide moulding compositions against thermo-oxidative or photo-oxidative degradation. The known stabilising systems include phenolic antioxidants, for example from the group of hindered phenols, antioxidants based on aromatic amines, as well as copper compositions. Mixtures of copper halides and alkali halides in particular have proved to be effective stabilisers against thermo-oxidative aging. The mixtures of copper halides and alkali halides are superior in their stabilising effect compared to the other stabilising systems. When polyamides are continuously used at temperatures above 120° C., organic stabilisation systems fail. At these temperatures, only stabilisers based on copper salts are effective when thermo-oxidative stability is required over several thousand hours. The stabilisers mentioned can be added to the polyamides in different ways, for example before or during polymerisation, dusting during the drying process, or by compounding.

### 2. DESCRIPTION OF RELATED ART

Examples of stabilisation of polyamide moulding compositions containing copper compositions are mentioned in EP 0 745 642 B1 and EP 0 668 943 B1. EP 0 745 642 B1 describes thermostable, weatherproof polyamide moulding compositions containing as stabiliser a mixture of a copper halide, one or more halogen compositions, and hypophosphorous acid, or a mixture of an alkali or an alkali earth salt of these acids in a specific molar ratio. The cited document states that this stabiliser mixture provides very good stabilisation against thermo-oxidative and photo-oxidative aging.

EP 0 668 943 B1 describes stabilised polyamide filaments comprising polyphthalamide, a copper-containing stabilising agent, and a functionalised polyolefin synergist, whereby the stabilising agent comprises a copper compound soluble in the polyphthalamide and an alkali metal halide, and the synergist is present in a quantity of 1 to 20% by wt.

Apart from the systems mentioned, additional substance mixtures have been described for the stabilisation of polyamides against thermo-oxidative and photo-oxidative degradation. U.S. Pat. No. 2,705,227 describes a ternary stabilising system composed of a copper compound, a halogen compound, and a phosphoric acid or an alkali salt of a phosphoric acid.

GB-A-1 140 047 describes a ternary stabilising system composed of a copper salt, a phosphoric or hypophosphorous acid or a compound of these acids, and an alkali halide. A restriction is imposed upon the claimed ternary stabilising system, in that the phosphorus compound can be used at most in half the molar quantity of the copper salt. If hypophosphorous acid is used as the phosphorus compound, in accordance with GB-A-1 140 047 it may be used for up to a maximum of one-fourth of the molar concentration of the copper salt. The phosphorus compound is added in the cited molar deficiency relative to the added quantity of copper in order to obtain a bright colour in the polyamine moulding compositions.

DE-A-2 107 406 describes a ternary stabilising system composed of copper stearate, potassium iodide, and manganese hypophosphite. The moulding compositions stabilised with this mixture are described as colourless.

EP-A-0 612 749 describes stabilised polyamine moulding compositions which contain an ionic or complex copper stabiliser in addition to elementary, finely dispersed copper as stabiliser.

The known stabiliser systems retard the thermo-oxidative and photo-oxidative ageing of polyamine moulding compositions. New applications increase the requirements for the stability of polyamine moulding compositions against thermo-oxidative or photo-oxidative degradation. This applies, for instance, to the use of polyamine moulding compositions in the engine compartment of automobiles. In this and other areas, the polyamine moulding compositions are exposed to a high thermal load over long periods of time. At these high temperatures, only copper-based stabilisers are suitable for polyamides.

The mechanism of stabilisation of polyamides through the combination of metal salts such as copper halides and alkali halides is described, for example, by P. Gijsman et al. in Polymer Degradation and Stability 49 (1995), 127-133. The combination of copper salts with aromatic halogen compositions is mentioned in DE-A-19847626, and the combination with complexing agents such as mercaptans or phosphines is mentioned in DE-A-19847627. With these systems, the discoloration of copper-base stabilisers is reduced.

The use of metal deactivators/antioxidants, such as sterically hindered phenols, is known from the prior art. Very often these compositions are used for the stabilisation of polyolefins, in particular for polyphenylene ether, or for continuous use in contact with copper, for example in cable applications.

For this type of stabilisation (of polyolefins) metal deactivators are used, which according to the literature source Plastics Additives Handbook, 4th Ed., 1993, Chapter 2.4 have the following chemical structures: amides of aliphatic and aromatic mono- and dicarboxylic acids and their N-monosubstituted derivatives, cyclic amides, such as barbituric acid, hydrazones and bishydrazones of aliphatic and aromatic aldehydes, hydrazides of aliphatic and aromatic mono- and dicarboxylic acids, bisacylated hydrazine derivatives, heterocyclic compositions such as melamines, benzotriazoles, 8-oxoquinolines, hydrazones, and acylated derivatives of hydrazinotriazines, aminotriazoles and acylated derivatives thereof, polyhydrazides, molecular combinations of sterically hindered phenols and metal complexing groups, nickel salts of benzylphosphonic acids, optionally in combination with other antioxidants or metal deactivators, pyridinethiol/Sn compositions, and tertiary phosphoric acid esters of thiobisphenol. Further structural classes are mentioned in the patent literature in this context, such as for example N,N′-bis-salicylalethylene diimide, salicylal oximine, derivatives of ethylenediamine tetraacetic acid, etc. However, in practice many of the compositions named above cannot be used as metal deactivators with thermoplastics due to their low activity and insufficient thermal stability, or because of their volatility.

The use of sterically hindered phenols in polyamine moulding compositions is also known from EP 1 198 520 B1.

Phenolic antioxidants from the group of sterically hindered phenols are understood by one skilled in the art to be organic compositions in general which contain at least one phenolic group, whereby the aromatic half is substituted at least at one, or preferably at both, positions, directly adjacent to the carbon atom containing the phenolic group. The substituents adjacent to the hydroxy group are alkyl radicals, preferably selected from the alkyl groups containing 1 to 10 carbon atoms. Said substituents are preferably tertiary butyl groups. Suitable hindered phenols comprise, for example, tetrakis(methylene(3,5-di-(tert)-butyl-4-hydrocinnamate))methane, known commercially as Irganox 1010 (Ciba Specialty Chemicals). It is also known to add such antioxidants containing hindered phenol groups to HT (high-temperature) polyamide injection moulding compositions to improve their thermal stability (see EP 1 198 520 B1).

EP 1 198 520 B1 describes injection moulding compositions comprising partially aromatic high-temperature polyamides containing aliphatic diamine terephthalamide units, olefinic impact resistance modifiers and a copper-containing thermal stabiliser comprising an alkali metal halide, a copper (I) halide in a weight ratio of 2.5:1 to 20:1, and a compound selected from secondary arylamines and hindered phenols. In accordance with EP 1 198 520 B1, besides an improvement in the thermal stability of an impact resistance-modified high temperature polyamide formulation, the formation of thermo-oxidative degradation products, which would result without heat stabiliser (hindered phenol), should also be prevented. According to EP 1 198 520 B1, partially aromatic polyamides are used which have a low content of amino end groups. In accordance with the general teaching of EP 1 198 520 B1, partially aromatic polyamides containing amino end groups in quantities of 25 μEq/g or less, that is, of 10 or 5 μEq/g, are used (see EP 1 198 520 B1, paragraph [0097]). The PPA3 and PPA4 polyamides preferably used in the examples of EP 1 198 520 B1 contain carboxyl end groups in quantities ranging from 91 to 86 μEq/g (see paragraphs [0085], [0086]). Together with the copper stabiliser, these compositions show a reduced extent of thermo-oxidative degradation products in moulds (see EP 1 198 520 B1, paragraph [0089]).

EP 1 198 520 B1 thus describes in another aspect the prevention of deposits in the case of partially aromatic polyamides containing sterically hindered phenols and copper stabilisers. However, other polyamides are also prone to formation of deposits when they are exposed to higher temperatures, for example in thermoplastic moulding. Depending on the type of polyamide, these deposits are composed of different proportions of monomers, oligomers, and various degradation products which arise during the processing.

Polyamide melts in thermodynamic equilibrium show specific concentrations of linear, and in some cases, cyclic, monomers, as well as linear and cyclic oligomers in addition to water. The low-molecular components affect the workability of the products, and lower the viscosity of the polymer melt. During injection moulding or extrusion processes, residual monomers, in particular lactams, and cyclic oligomers evaporate and have a disruptive effect through formation of coatings, with solid coatings being particularly problematic.

Like all polymers produced in multi-stage growth reactions, polyamides by their very nature contain small concentrations of residual monomers and oligomers.

Monomers and/or oligomers are generally separated from the polyamide granules by static or dynamic extraction with water, methanol, ethanol, ethanol/water, or chloroform. According to DIN 53378 and/or DIN ISO 6427, polyamide powders of a specific grain size are to be extracted under specific conditions with methanol. Monomers always occur in a mixture with oligomers. These can be separated more or less completely from the polyamides, according to the type and molar mass, depending on the extraction conditions.

For the amorphous, partially aromatic copolyamides, however, there is the problem that an extraction with the usual solvents such as methanol or dichloromethane does not deliver appreciable quantities of extract because of the high glass transition temperature of the products, and the polymer material coalesces when higher-boiling alcohols are used.

For partially aromatic polyamides and the so-called HT polyamides such as PA 6T/6I, besides residual monomers and oligomers, as previously mentioned, low-molecular degradation products formed during production and processing should also be taken into account with regard to coating formation.

It is therefore desirable to remove and/or avoid the above-mentioned low-molecular components and oligomers as much as possible, so that no further solid deposits or coatings develop during the subsequent thermoplastic processing.

Polyamide 12 (PA 12) is a type of polyamide characterised by a particularly interesting property profile. Polyamide 12 can be modified in a variety of ways, and the resulting moulding materials can subsequently be thermoplastically transformed very well in injection moulding and extrusion processes into articles of high practical value. Overall, polyamide 12 corresponds to the type of polyamide whose characteristics are least affected in practical use by changes in temperature and humidity.

However, one problem is that in the common hydrolytic polymerisation process/autoclave process, monomer conversion is only approximately 99.5%, and the residual lactam in the polymer is poorly soluble, so that, particularly during processing of the melt and also in later practical use, this results in exudation and sublimation of lactam 12 (LC12), especially on cooled surfaces, e.g. the surfaces of moulds and finished parts, and thus resulting in formation of coatings. In particular because of the high melting point of lactam 12, such sublimates often form fouling deposits which, especially when the additives migrate to the surface, lead to processing defects with surface damage and thus to interruptions in production, and can also form so-called “black spots”. Known measures for the reduction and elimination of lactam 12-residues are, e.g., the molten or solid-phase post-condensation under vacuum, as well as liquid extraction processes or reprecipitation from alcoholic solution. Even these processes, in which lactam evaporates under the influence of heat, can be disrupted by lactam sublimate. Furthermore, lactam mist is highly combustible, and the processes require special precautionary measures. In addition, the additional thermal load can damage the polymer. During the thermoplastic processing of polyamide 12 (PA12) moulding materials in the injection moulding procedure and in extrusion, the formation of solid deposits, especially those consisting of lactam 12 (LC 12), has a detrimental effect.

Therefore, simple, cost-effective measures for preventing the formation of solid deposits or coatings during subsequent thermoplastic processing of polyamine moulding compositions are required, which are based in particular on polyamide, particularly preferably on polyamide 12, or also on a copolymer and/or a polyamide based on polyamide structural units and components respectively, in particular polyamide 12 structural units.

The above-mentioned moulding compositions find application in thermoplastic moulding of articles, for example in continuous processes such as extrusion to form films, pipes, and sheathings. In recent years, plastic pipes for liquid media have been increasingly used in the automobile sector for special applications, for example for cooling water, fuel, brake fluids, etc.

In this context, cooling water pipes consisting of only one polymer layer, so-called monopipes, as well as multi-layer pipes are used. Multi-layer pipes are used with and without glass fibre reinforcement.

Coolant lines usually have complicated, not simple, geometries, and are often composed of metal parts and flexible intermediate pieces to compensate for the occasionally intensive vibrations of the engine. For this reason, in accordance with the prior art, rubber pipes reinforced with fibrous tissue are used. Such rubber pipes, used preferably for motor vehicle engines, have the disadvantage of being relatively expensive and not completely adequate, particularly at high temperatures produced in the engine compartment. After a service life of about 100,000 kilometres the mechanical characteristics deteriorate dramatically. The stability of rubber cooling water pipes becomes even more critical for future automobile engines, which allow the temperatures in the engine compartment to rise even higher than previously, thereby further accelerating the deterioration of the mechanical characteristics.

EP-A-0 659 534, for example, discloses sequentially extruded coolant lines with a bursting pressure-resistant external layer and a non-swellable interior layer for cooling agents, whereby the outside layer consists of a polyamide and the interior or intermediate layer compatible with the outside layer consists of polyolefins modified with carboxyl or acid anhydride groups.

WO 94/18485 primarily describes pipe structures for conducting alcoholic fuels. The materials used are standard polyamides with a balanced amino-to-carboxyl end group ratio as external layer, HDPE copolymers with acrylic acid or maleic anhydride as intermediate layer, and an HDPE as interior layer, which can be crosslinked using steam. The use of coolants is not mentioned in WO 94/18458.

EP 0 542 184 B1 further describes multi-layered pipes with good blocking action for conducting aromatic or aliphatic solvents as well as fuels. The internal and external layers are usually formed from polyamides, the connecting intermediate layer from common linear polyesters, and partly from polymers that are preferably functionalised with reactive acid groups.

The problem with the previously described multi-layered pipes is that they do not withstand repeated use, particularly at higher temperatures and under the influence of certain conducted liquids. Said pipes become susceptible to stress cracks and as a result become brittle or have too low a resistance to hydrolysis and become prone to delamination of layers. The reasons for these phenomena are on the one hand the insufficient adhesion between the individual layers, and on the other hand the insufficient resistance of the polymer materials to increased stress.

In EP 0 754 898 B1 (EMS-Chemie AG), therefore, three-layered, flexible coolant lines with high hydrolysis and bursting pressure resistance are provided, whose external layer consists of a particular polyamide, namely polyamide 12, with an excess of amino end groups. The interior layer of this coolant line consists of crosslinked polyethylene, and the intermediate layer consists of a material compatible with the external and internal layers. The described polyamides with an excess of amino end groups exhibit a clearly improved and more resistant adhesion to polyolefins with functional side groups. This adhesion does not loosen or weaken even with continuous exposure to heat and water.

Furthermore, co-extruded, tubular multi-layer compositions are also known which have a corrugated wall for increased flexibility. EP 0 436 923 B2 (EMS-Chemie AG) describes by way of example flexible coolant lines with high hydrolysis and bursting pressure resistance for engines, which are manufactured by co-extrusion from the polymer components and possess a polyolefinic internal layer as well as a polyamide external layer. Polyamide in the external layer ensures a high bursting pressure resistance and facilitates the achievement of 8 bar/120° C. specified by the automobile manufacturers, so that the fibrous tissue which is essential for rubber coolant lines can be omitted. The required flexibility, which results from the necessity to enable sharp line bends within a narrow space, is achieved by the so-called corrugated pipes, the walls of which can be corrugated in annular or spiral shapes, for example, using procedures known from the prior art.

The corrugated pipes in accordance with EP 0 436 923 B2 are considerably more flexible than, for example, reinforced rubber pipes from the prior art.

Thermoplastic coolant lines are further known from the documents DE-A-4000434, DE-GM 9402180.5, DE-GM 9319879.5, DE-GM 9319880.9, and DE-A-4432584.3.

DE-A-4000434 describes a flexible coolant line having a two-layer design, the internal layer being a polyolefin provided with functional groups and the external layer being composed of polyamides of the group of homo- or copolyamides or blends thereof. Coolant lines of this configuration which are designed as thermoplastic corrugated pipes have the disadvantage that conventionally polymerised polyamides exhibit an enormous resistance to hydrolysis, and that the grafted polyolefins used in accordance with DE-A-4000434 are strongly prone to stress cracks upon contact with anti-freeze agents and at temperatures greater than 100° C.

Furthermore, it is very important for the interior layer of thermoplastic coolant lines that the permeation of coolant and water is as low as possible, since these liquids damage the bursting pressure-resistant external layer.

A further disadvantage of coolant lines according to DE-A-4000434 lies in the fact that the inter-laminar adhesion between polyamides and polyolefins, which are grafted with functional groups, is lost after extended perfusion of cooling agents at high temperatures, thus resulting in delamination.

Therefore, there has been a need to provide process-stable and hydrolysis-resistant polyamide moulding compositions with good process stability and thermal resistance in addition to stable processing characteristics. The moulding compositions should be able to be used in particular for the production of single- or multi-layered coolant lines. During the thermoplastic moulding no further coatings should develop and/or should be largely prevented.

Tests by the inventors for the present application have shown that the interaction between the amino end groups of the polyamide (which must be present in surplus for resistance to hydrolysis, i.e. in high concentration) and the copper compositions causes the viscosity of the polyamine moulding compositions to greatly increase. This viscosity influence and formation of gel particles depends upon the concentration of the amino end groups and the processing conditions, including drying temperature and drying duration. In industrial manufacturing processes, however, such varying viscosities are not acceptable.

Due to the high melt viscosity higher processing temperatures are necessary, which also intensifies the formation of deposits composed of residual monomers present in the polyamides.

Residual monomers in the polyamide cause deposits on the moulding jaws during subsequent processing, i.e., during thermoplastic moulding.

### BRIEF SUMMARY OF THE INVENTION

Thus, it is an object of the present invention to provide polyamide moulding compositions containing the components (A), (B), (C), and optionally (D) and/or (E).

### DETAILED DESCRIPTION OF THE INVENTION

The above object is achieved by the thermoplastic polyamine moulding compositions according to claim 1 containing the following components (A), (B), (C), and optionally (D) and/or (E):

(A) At least 20% by wt. polyamide and/or at least one copolymer containing at least 20% by wt. polyamide structural units, whereby the polyamide and/or the polyamide structural units are based on aliphatic C₆-C₁₂ lactams or ω-aminocarboxylic acids containing 4 to 44 carbon atoms, preferably containing 4 to 18 carbon atoms, or are based on aromatic ω-aminocarboxylic acids containing 6 to 20 carbon atoms or are polycondensates obtainable from the polycondensation of at least one diamine from the group of aliphatic diamines containing 4 to 18 C atoms, cycloaliphatic diamines containing 7 to 22 C atoms in combination with at least one dicarboxylic acid from the group of aliphatic dicarboxylic acids containing 4 to 44 C atoms, cycloaliphatic dicarboxylic acids containing 8 to 24 C atoms, and aromatic dicarboxylic acids containing 8 to 20 C atoms, whereby in each case the polyamide and/or the at least one copolymer containing at least 20% by wt. polyamide structural units have an amino end group content in the range of 25 to 300 μEq/g, preferably from 50 to 300 μEq/g, and a carboxyl end group content of less than 20 μEq/g, preferably less than 15 μEq/g, in each case relative to the polyamide portion and/or the portion of polyamide structural units;
(B) 0.01% by wt. to 2% by wt., relative to the polyamide portion and/or the portion of polyamide structural units of the composition, of a copper-containing stabiliser, in particular comprising an alkali metal halide and a copper (I) halide and/or a copper (I) stearate and/or a copper (I) oxide, particularly preferably in a weight ratio of alkali metal halide to the sum of the copper compositions of 2.5:1 to 100:1;
(C) 0.01% by wt. to 3% by wt., relative to the polyamide portion and/or the portion of polyamide structural units of the composition, of at least one organic compound containing metal complexing groups, selected from the group of acid amide, oxamide, oxalanilide, hydrazine, acid hydrazide, or hydrazone groups, as well as from the group of benzotriazoles, so that the copper ions are present in complexed form through binding to the metal-complexing groups; and optionally
(D) 0.05% by wt. to a maximum 15% by wt., preferably 0.1% by wt. to 3% by wt., in each case relative to the polyamide portion and/or the portion of polyamide structural units of the composition, of at least one compound of a softener, selected from the group comprising benzenesulfonic acid alkylamides, o-, p-toluenesulfonic acid alkylamides, alkylhydroxybenzoates, benzenecarboxylic acid esters, phthalic acid esters, fatty acid esters, esters of polyvalent alcohols, dicarboxylic acid diesters with a carbon number of the acids of 4 to 44 atoms, trialkylmellitic acid esters, phosphoric acid esters, citric acid esters, tetraalkyl alkylenediamines, tetra(2-hydroxyalkyl)alkylenediamines, trialkylamines, and mixtures of the aforementioned compositions; and/or
(E) 0.05% by wt. to a maximum 15% by wt., preferably 0.3% to 3% by wt., in each case relative to the polyamide portion and/or the portion of polyamide structural units of the composition, of at least one aprotic compound selected from the group of N-alkylated, cyclic carboxylic acid amides containing 5-7 ring members and/or from the group of the urea derivatives, whose alkyl residues on the nitrogen are linear or branched and optionally can contain heteroatoms and heterogroups or form a linkage of the two N atoms.

The metal-complexing groups of component (C) according to the invention are acid amide, oxamide, oxalanilide, hydrazine, acid hydrazide, or hydrazone units, as well as benzotriazoles. Compositions with such structures act as metal deactivators (see Plastics Additives Handbook, 4th Ed., 1993, Chapter 2.4).

The copper ions of the copper-containing stabiliser (B) are bonded by adding metal-complexing groups of component (C). In addition to the metal-complexing groups, the compositions of component (C) can contain further functional groups such as alcoholic or phenolic groups and/or arylamines.

In a preferred embodiment of the invention, component (C) is present in a molar ratio to the sum of the copper (I) compositions of 0.5:1 to 3:1. Component (C) is preferably added in at least an approximate equimolar quantity with respect to the quantity of copper of component (B) during the production of the thermoplastic moulding compositions.

Examples of compositions of component (C) of the type according to the invention are 2′,3-bis[[3-[3,5-di-tert-butyl-4-hydroxyphenyl]propionyl]]propionohydrazide and/or 2,2′-oxamido-bis[ethyl-3-(3,5-di-tert-butyl-4-hydroxyphenyl)propionate] and/or 3-(salicyloylamino)-1,2,4-triazole.

Surprisingly, it has been shown that by addition of an organic compound containing metal-complexing groups such as for example acid amide, oxamide, oxalanilide, hydrazine, acid hydrazide, or hydrazone units or benzotriazoles to a polyamide, which on the one hand has a surplus of amino end groups, i.e., in the range of 25 to 300 μEq/g amino end groups, in particular from 50 μEq/g and up to 300 μEq/g amino end groups, as well as a carboxyl end group content of less than 20 μEq/g, preferably less than 15 μEq/g, and on the other hand possesses copper stabilisation, for example based on copper (I) iodide and potassium iodide, the processing stability can be markedly improved without impairing the long-term thermal stability above 120° C. and the resistance to hydrolysis. In the context of the present invention, it is acknowledged for the first time that even if copper is present in complexed form as the result of component (C), the desired heat stabilisation is maintained by the copper.

In principle, it has been possible to show in the present invention that by using copper stabilisation according to the invention and metal deactivator for polyamides with a balanced end group ratio together with copper iodide, no more pinholing occurs during film tests, and therefore this problem, which arises with highly viscous polyamide 12 in particular, has henceforth been eliminated.

According to the invention, polyamides are used which have a surplus of amino end groups. A high resistance to hydrolysis is obtained according to the invention by the high surplus of amino end groups of the polyamides and/or the polyamide structural units. The life span of the pipes according to the invention is clearly increased by this characteristic in relation to comparable pipes.

In practice, the quantity of the copper-containing stabiliser system is selected in such a manner that a content of 50 to 1000 ppm copper is present relative to the polyamide. The weight ratio of the alkali metal halide to the copper (I) halide and/or copper (I) stearate and/or copper (I) oxide lies in a range from 2.5:1 to 100:1. Generally, the combined weight portion of the copper compound and the alkali metal halide in stabilised polyamide is 0.01 to 2.0% by wt., preferably 0.1 to 1.5% by wt., based on the total weight of the composition.

The alkali metal halide used according to the invention is preferably sodium or potassium iodide, and the copper (I) halide is preferably copper (I) iodide. However, according to the invention copper (II) acetate in conjunction with potassium iodide can also be used. Optionally a synergist may be added to the copper stabiliser, the synergist being present in a quantity of 1 to 20% by wt. relative to the total polymer composition. The synergist can, for example, be a phosphine.

In order to reduce the formation of solid deposits, additional compositions such as softeners and/or aprotic compositions such as carboxylic acid amides or ureas in quantities of 0.05% to 15% by wt., relative to the polyamide portion and/or the portion of polyamide structural units, can be added to the polyamine moulding compositions (see the above-mentioned components (D) and (E)).

Due to simultaneous leakage of monomers and/or oligomers and/or degradation products of the polyamides and compositions (D) and/or (E) during the thermoplastic moulding, no solid coatings deposit on the cold moulded part surface, but rather, fine, medium- to low-viscosity droplets or liquid films, which either flow away spontaneously, can be easily wiped away, or if they remain on the surface, diffuse back into the polyamide moulding composition. These films contain the monomers, oligomers, or degradation products sublimated from the polyamide matrix in soluble, dispersed, or suspended form. Thus, disruptive solid deposits which cause scaling or cracks during continuous processing due to the prevailing conditions are converted into low-viscosity coatings that are non-disruptive or easily removable.

Compositions (D) and/or (E) exhibit solubility parameters comparable to the polyamide components used, and are therefore sufficiently compatible and polar, so that even the monomers, oligomers, and the degradation products of the polyamides can be dissolved partly or completely thereby. Because of the good compatibility of compositions (D) and/or (E) with the polyamide matrix and the sublimating monomers, oligomers, or degradation products, small concentrations of these additives are sufficient to prevent disruptive solid coatings.

Due to their high reactivity, some of the compositions (D) and/or (E) according to the invention can dissolve the sublimates created during the processing. For example, proton-donating components of the sublimate are neutralised by (hydroxyalkyl)ethylenediamine. Thus, the otherwise sparingly soluble dicarboxylic acids, such as for example terephthalic acid, can be put into solution or at least in a dispersed form, thereby preventing the formation of solid coatings.

This is advantageous particularly in the case of so-called HT polyamides, which are based on 6T, such as PA 6T/6I, since here, by the inventive use of tetra(2-hydroxyalkyl)ethylenediamines, in particular of N,N,N′N′-tetrakis(2-hydroxypropyl)ethylenediamine, neutralisation causes the sublimated terephthalic acid to go into solution.

Although the sublimation of the residual monomers or oligomers in the polyamide 12, or the degradation products formed during the processing, are not prevented by the new use of the coating-reducing compositions (D) and/or (E) according to the invention, the additional components of the formulation are able to liquefy these materials.

Portions of compositions (D) and/or (E), but also monomers and oligomers which migrate to the test piece surface during the processing, undergo back-diffusion into the polyamide moulding composition in the temperature range of, for example, 50° C. to 100° C., that is, under conditions corresponding to common practical use, which is to be regarded as a desirable characteristic. In the case of polyamide 12, one can explain this unexpected result in such a way that compositions (D) and/or (E), in particular N-octylpyrrolidone, N-butylbenzenesulfonamide (BBSA), or N-butyltoluenesulfonamide, dissolve in the polyamide 12 matrix, and since N-octylpyrrolidone is also capable of dissolving lactam 12, enables its back-diffusion into the matrix. Compositions (D) and/or (E) therefore probably act in such a way that, although the sublimation of lactam 12 cannot be prevented, in place of solid coatings fine, colourless, low-viscosity droplets form which flow away spontaneously, and which can be easily wiped away, or if they remain on the surface, diffuse back into the compound.

In this manner, the problem of solid deposits with polyamine moulding compositions can be largely solved, in particular for polyamide 12 moulding compositions, and co-polymers containing at least 20% by wt. polyamide 12 structural units and/or components relative to the total moulding compound, by means of a mere supplement to the formulation for technical applications. Therefore, no additional process steps, and thus no additional thermal loads on the moulding compositions, are necessary.

According to the invention, compositions (D) and/or (E) effectively prevent the formation of solid deposits with an added amount of 0.05 to a maximum 15% by wt. in each case, relative to the polyamide component, which is dictated in particular by lactam 12 (laurinlactam). Added quantities of 0.1% to 3.0% by wt. are preferred, and added quantities of 0.15% to 2.0% by wt. are particularly preferred.

Examples of phthalic acid esters for use as deposit-reducing additive, referred to in abbreviated form below as “aA”, include predominantly phthalic acid esters containing linear or branched C₄ to C₁₄ alcohols such as diethyl phthalate, dibutyl phthalate, butyl octyl phthalate, butyl isodecyl phthalate, diisooctyl phthalate, dicapryl phthalate, n-octyl-n-decyl phthalate, diethyl phthalate, diisobutyl phthalate, diheptyl phthalate, di-2-ethylhexyl phthalate, diisodecyl phthalate, butyl benzyl phthalate, diisononyl phthalate, di-2-ethylhexyltetrahydro phthalate, and dimethoxyethylene phthalate.

Examples of fatty acid esters for use as “aA” include di-2-ethylhexyl adipate, diisodecyl adipate, diisononyl adipate, di-2-ethylhexyl sebacate, di-2-ethylhexyl azelate, bis-2-ethylene hexyl dodecandioate, bis-2-ethyhexyl fumarate, dibutyl maleate, acetylbutyl ricinoleate, tributylacetyl citrate, and 2-ethylhexyl acetate.

Examples of esters of polyvalent alcohols to be used as “aA” include 2,2,4-trimethyl-1,3-pentanediol monoisobutyrate, 2,2,4-trimethyl-1,3-pentanediol diisobutyrate, glycerine triacetate, and glycerine tributyrate.

Examples of the phosphoric acid esters for use as “aA” include triphenylphosphate, cresyldiphenylphosphate, tricresylphosphate, trimethylphosphate, triethylphosphate, tributylphosphate, tri-2-ethylhexylphosphate, tributoxyethylphosphate, and 2-ethylhexyldiphenylphosphate.

Examples of the trimellitic acid ester for use as “aA” include tribtuyl trimellitate, tri(2-ethylhexyl)trimellitate, and tri(n-octyl)trimellitate.

Examples of the epoxy softener for use as “aA” include di-n-octylepoxyhexahydrophthalate and di-2-ethylhexylepoxyhexahydrophthalate.

Preferred representatives of the above-listed “aA” according to the invention include phthalic acid esters such as for example diisobutyl phthalate, diheptyl phthalate, di-2-ethylhexyl phthalate, and diisodecyl phthalate, fatty acid esters such as di-2-ethylhexyl adipate, isodecyl adipate, di-2-ethylhexyl sebacate, and di-2-ethylhexyl azelate, esters of polyvalent alcohols such as for example 2, 2,4-trimethyl-1,3-pentanediol monoisobutyrate and 2,2,4-trimethyl-1,3-pentanediol diisobutyrate, and phosphoric acid esters such as for example tributylphosphate, tri-2-ethylhexylphosphate, and tributoxyethylphosphate.

Particularly preferred compositions of group (D), which preferably are used as “aA” in the invention, are phthalic acid esters such as for example diisobutyl phthalate, di-2-ethylhexyl adipate, di-2-ethylhexyl sebacate, and di-2-ethylhexyl azelate, polyvalent alcohols such as for example 2, 2,4-trimethyl-1,3-pentanediol monoisobutyrate and 2,2,4-trimethyl-1,3-pentanediol diisobutyrate, and phosphorous esters such as for example tri-2-ethylhexylphosphate.

Examples of the benzenesulfonic acid alkylamides for use as “aA” include benzenesulfonic acid propylamide, benzenesulfonic acid butylamide, and benzenesulfonic acid-2-ethylhexylamide.

Examples of the toluenesulfonic acid alkylamides for use as “aA” include N-ethyl-o- or N-ethyl-p-toluenesulfonic acid butylamide and N-ethyl-o- or N-ethyl-p-toluenesulfonic acid-2-ethylhexylamide.

Examples of the alkylhydroxybenzoates for use as “aA” include ethylhexyl-o- or p-hydroxybenzoate, hexyldecyl-o- or p-hydroxybenzoate, ethyldecyl-o- or p-hydroxybenzoate, methyl-o- or p-hydroxybenzoate, butyl-o- or p-hydroxybenzoate, hexyl-o- or p-hydroxybenzoate, n-octyl-o- or p-hydroxybenzoate, decyl-o- or p-hydroxybenzoate, diethylene glycol dibenzoate, and dodecyl-o- or p-hydroxybenzoate.

Examples of dicarboxylic acid diesters are hexane diacid diesters, such as benzyloctyl adipate (Adimoll BO®), dimethyl adipate (Adimoll DM®), nonanedioic acid diesters, for example di-n-hexyl azelate (Edenol 9051®), and decanedioic acid diesters, for example dioctyl sebacate (Edenol 888®).

Examples of trialkyl trimellitate are 1,2,4-benzenetricarboxylic acid-tris(alkyl ester), such as trioctyl trimellitate (Palatinol TOTM-I®).

An example of the tetra(2-hydroxyalkyl)ethylenediamine used is N,N,N′,N′-tetrakis(2-hydroxypropyl)ethylenediamine (Quadrol®).

An example of penta(2-hydroxyalkyl)alkylenetriamine is Pentrol®, the addition product of propylene oxide to diethylenetriamine.

Preferred representatives of the above-listed “aA” according to the present invention include benzenesulfonic acid alkylamides, such as for example benzenesulfonic acid butylamide and benzenesulfonic acid-2-ethylhexylamide, toluenesulfonic acid alkylamides, such as for example N-ethyl-p-toluenesulfonic acid butylamide and N-ethyl-p-toluenesulfonic acid-2-ethylhexylamide, and alkylhydroxy benzoate, such as for example ethylhexyl-p-hydroxy benzoate, hexyldecyl-p-hydroxy benzoate, and ethyldecyl-p-hydroxy benzoate.

Particularly preferred members of these include benzenesulfonic acid butylamide, ethylhexyl-p-hydroxy benzoate, and hexyldecyl-p-hydroxy benzoate.

The “aA” effectively prevents the formation of solid deposits, particularly when added in the amount of 0.15% wt. to 2.0% wt. in the polyamide matrix component.

An aprotic compound from the group of the N-alkylated, cyclic carboxylic acid amides with 5-7 ring members preferably corresponds to a carboxylic acid amide of formula I:

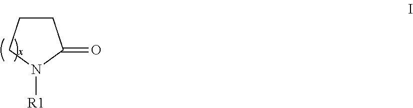

where x is 1 to 3, and R1 is 1 to 12 C atoms and can also contain heteroatoms and heterogroups, especially —O— bridges. Suitable compositions are N-alkylpyrrolidones and/or N-alkylcaprolactams, in which R1 is isopropyl, butyl, tert-butyl, hexyl, octyl, dodecyl, cyclohexyl, 2-hydroxyethyl, 3-hydroxypropyl, 2-methoxyethyl, or 3-methoxypropyl. Specific suitable compositions are N-octylpyrrolidone and N-octylcaprolactam.

According to the invention, N-octylpyrrolidone or BBSA is particularly suitable as an additive. Lactam 12 and N-octylpyrrolidone both have a molecular weight of 197 g/mol and both are cyclic amides. Furthermore, N-octylpyrrolidone or BBSA and lactam 12 volatilise in approximately the same temperature range. Whereas N-octylpyrrolidone or BBSA volatilise at high temperature, re-diffusion takes place in the polyamide 12 matrix in the temperature range from 100 to 150° C. A significant difference between the two compositions is the melting point. Thus, lactam 12 has a melting point of 150° C. and is therefore a solid at room temperature, while N-octylpyrrolidone or BBSA is a liquid at room temperature. A significant characteristic of N-octylpyrrolidone or BBSA with respect to the present invention is that it is able to dissolve or liquefy lactam 12. N-octylcaprolactam shows behaviour similar to N-octylpyrrolidone, with somewhat lower solubility for lactam 12.

In order to ensure that no droplets or thin liquid films and solid deposits are formed during processing, not only is sufficient solubility of lactam in compositions (D) or (E) necessary, but also a volatility of compositions (D) and/or (E) modified to the lactam, as well as a sufficient solubility in the PA12 matrix and a favourable migrating behaviour, are crucial. A slightly higher or equivalent volatility of the aprotic compound in relation to the lactam is advantageous.

However, the volatility should not under any circumstances be so high that the disadvantages of excessive emission formation more than outweigh the advantages with regard to the deposit problem.

According to the invention, compositions (D) and/or (E), even at higher concentrations, do not result in a degradation of the basic polyamide moulding compositions, so that the mechanical characteristics remain unchanged.

Further preferred compositions of group (E) are urea derivatives of formula II

R′/R2-N—CO—N—R2/R′ II

where R2 and R′ can be different or identical, linear or branched, and can contain 1 to 8 C atoms, or every two R′ moieties can be an ethylene or propylene bridge which links the two N atoms. Particularly preferable is the compound in which R2 and R′ are butyl residues. Furthermore, the cyclic N,N-dimethylethylene and -propylene urea as well as tetrabutyl urea and mixtures of such urea derivatives are particularly suitable. In a particularly preferred embodiment, the urea derivatives are used as mixtures with the cyclic N-alkylcarbonamides. If the moulding compositions contain deposit-reducing additives in accordance with formula I and/or formula II, during the thermoplastic processing extremely low-viscosity, colourless droplets or liquid films, which flow or drip away or which can be wiped off easily, are formed at cold places on the mould or on surfaces of the moulded object, but no adhering coatings are formed.

The term “polyamide” (generic term) is understood to refer to homo- or copolyamides or blends, mixtures, or alloys of homo- and/or copolyamides, in the context of the present invention.

As polyamides for the moulding compositions according to the invention, polycondensates according to the invention obtained from aliphatic lactams or ω-aminocarboxylic acids containing 4 to 44 carbon atoms, preferably containing 4 to 18 carbon atoms, or those from aromatic ω-aminocarboxylic acids containing 6 to 20 carbon atoms, are used which contain

(A) at least 20% by wt. polyamide and/or at least one copolymer containing a minimum 20% by wt. polyamide structural units, where the polyamide and/or the polyamide structural units are based on aliphatic C₆-C₁₂ lactams or ω-aminocarboxylic acids containing 4 to 44 carbon atoms, preferably containing 4 to 18 carbon atoms, or based on aromatic ω-aminocarboxylic acids containing 6 to 20 carbon atoms, or are polycondensates obtainable from the polycondensation of at least one diamine from the group of the aliphatic diamines containing 4 to 18 C atoms, cycloaliphatic diamines containing 7 to 22 C atoms in combination with at least one dicarboxylic acid from the group of aliphatic dicarboxylic acids containing 4 to 44 C atoms, cycloaliphatic dicarboxylic acids containing 8 to 24 C atoms, and aromatic dicarboxylic acids containing 8 to 20 C atoms, whereby in particular, in each case the polyamide and/or the at least one copolymer containing at least 20% by wt. polyamide structural units has an amino end group content in the range of 25 to 300 μEq/g, in particular from 40 to 300 μEq/g, and a carboxyl end group content of less than 20 μEq/g, in particular less than 15 μEq/g, relative to the polyamide portion and/or the portion of polyamide structural units.
(B) 0.01% to 2% by wt., relative to the polyamide portion and/or the portion of polyamide structural units of the composition, of a copper-containing stabilising agent, in particular comprising an alkali metal halide and a copper (I) halide, and/or a copper (I) stearate, and/or a copper (I) oxide, preferably in a weight ratio of the alkali metal halide to the sum of the copper compositions of 2.5:1 to 100:1;
(C) 0.01 to 3% by wt., relative to the polyamide portion and/or the portion of polyamide structural units of the composition, of at least one organic compound containing metal-complexing groups selected from the groups of the acid amide, oxamide, oxalanilide, hydrazine, acid hydrazide, or hydrazone groups, as well as the group of benzotriazoles, so that the copper ions are present in complexed form by binding to the metal-complexing groups.

Likewise suitable as polyamides are polycondensates according to the invention obtained from at least one diamine and at least one dicarboxylic acid containing 2 to 44 carbon atoms in each case. Examples of such diamines are ethyldiamine, 1,4-diaminobutane, 1,6-diaminohexane, 1,10-diaminodecane, 1,12-diaminododecane, m- and p-xylylenediamine, cyclohexyldimethyleneamine, bis-(p-aminocyclohexyl)methane, and alkyl derivatives thereof.

Examples of dicarboxylic acids are succinic acid, glutaric acid, adipic acid, pimelic acid, suberic acid, azelaic acid, sebacic acid, dodecanedicarboxylic acid, 1,6-cyclohexanedicarboxylic acid, terephthalic acid, isophthalic acid, and naphthalenedicarboxylic acid.

Specific examples of the polyamides used in the context of the present invention and the (co)polyamides to be additionally incorporated into the mixtures or alloys for the moulding compositions according to the invention are homo- or copolyamides from the group of PA 6, PA 66, PA 11, PA 46, PA 1212, PA 1012, PA 610, PA 612, PA 69, PA 9T, PA 10T, PA 12T, PA 12I, PA 6T/12, PA 12T/12, PA 10T/12, PA 12T/106, PA 10T/106, PA 6/66, PA 6/612, PA 6/66/610, PA 6/66/12, and mixtures or copolyamides thereof, as well as PA 6T/66, PA 6/6T, PA 6/66/6T, PA 6/6I, PA 6T/6I, PA 6I/6T, PA 16/6T/66, PA 12/6T/6I, or mixtures or copolyamides thereof, as well as polyamides from the group of PA 12/MACMI, PA 66/6I/6T, PA MXD 6/6. Dimerised fatty acids containing 36 and 44 C atoms can also be used as monomers. For a high resistance to hydrolysis, polyamides according to the invention are used which have a high surplus of amino end groups. This is attained by the fact that the polyamides have a high number of NH₂ end groups.

In practice, a surplus of amino end groups can be established, for example, by adding a mono- or diamine during polymerisation of lactams, or, in cases of polyamides of type AA-BB, by using excess diamine in a targeted manner.

The polyamide moulding compositions according to the invention may contain at least 20% by wt., preferably at least 30% by wt., particularly preferably at least 40% by wt., polyamide as component (A). Furthermore, it is also possible to use a copolymer containing polyamide structural units, either in addition to the referenced polyamide or alone. This copolymer can contain at least 20% by wt. polyamide structural units. In one preferred embodiment, this copolyamide contains at least 30% by wt. polyamide structural units, particularly preferably at least 40% by wt. polyamide structural units. The copolymer can be a polyamide 12 block copolymer containing polyester, polyether, polysiloxane, polycarbonate, polyacrylate, polymethacrylate, or polyolefin segments as additional structural units in addition to a portion of at least 20% by wt., preferably 30% by wt., particularly preferably 40% by wt., polyamide structural units (see claim 21).

Other polymers which may be contained in the polyamide moulding compositions according to the invention are functionalised polymers, including homo- or copolymers from olefins, which are grafted with acrylic acid or maleic anhydride.

Of course, the thermoplastic polyamide moulding compositions according to the invention may additionally contain common additives generally known to those skilled in the art, singly or in combination, which are selected from the group comprising fillers, impact resistance modifiers, other polymers besides polyamides, bonding agents, reinforcing agents such as glass and C fibres, UV light or heat stabilisers, stabilisers against weathering, minerals, processing aids, crystallisation accelerators or inhibitors, oxidation inhibitors, flowability agents, lubricants, mould removers, flame-proofing agents, pigments, dyes and marking agents, antistatic agents such as carbon black or graphite, or as nanoscale fillers also platelike nanoparticles, corresponding to all known additives for polyamides as are necessary for the respective application.

For certain purposes, other common non-polyamide polymers such as polyesters, polyolefins, polycarbonates, acrylonitrile (AN) and ABS polymers, functionalised copolyolefins, and ionomers can also be added to the previously described (co)polyamides or mixtures thereof.

As further additives for the thermoplastic polyamide moulding compositions according to the invention, impact resistance modifiers may be used. These are, for example, copolymers based on polyolefins of low glass transition temperature which may contain acrylic acid or which may be grafted with maleic anhydride. Particularly mentioned are impact resistance modifiers such as ethylene-propylene copolyolefins or ethylene-propylene-diene-rubber (EPDM) or acrylate rubber.

In one preferred embodiment, the moulding compositions further contain nanoscale fillers. In one particular embodiment of the invention, the nanoscale fillers are either silicon dioxide or silicon dioxide hydrates. In one embodiment, certain nanoscale fillers are present in the polyamide moulding composition as a uniformly dispersed, layered material. Before incorporation into the matrix, they have a layer thickness of 0.7 to 1.2 nm and an interlayer distance of the mineral sheets of up to 5 nm.

Compositions (D) and/or (E) in accordance with claim 1 containing a polar functional group and a polar alkyl residue may significantly facilitate the incorporation of such fillers. When added to layered silicates, their polar group can function as a coordination site for the cation, thereby causing the interlayer distance to increase and thus significantly improving and accelerating the separation of the primary particles (exfoliation) and their distribution in the matrix.

Such minerals can be added at any stage of the polymer manufacturing and be finely distributed on the nanometer scale. Preferred are minerals that already have a layered structure, such as layered silicates (preferably montmorillonite), and double hydroxides such as hydrotalcite or also graphite. Nanofillers based on silicones, silica, or silsesquioxanes can be used as well.

In the sense of the invention, 1:1 and 2:1 layered silicates are considered layered silicates. In these systems, layers of SiOₜ tetrahedra are connected with those of M(O,OH)₆ octahedra in a uniform manner. M stands for metal ions such as Al, Mg, and Fe. For the 1:1 layered silicates, each tetrahedron layer is connected to one octahedron layer. Examples are kaolin and serpentine minerals.

In one embodiment of the invention, for the preparation of thermoplastic polyamide moulding compositions according to the invention the “aA” is added to granulates of (co)polyamide containing at least 20% polyamide 12, and is mixed until the compound has diffused into the granulates. The mixing is preferably performed at higher temperatures, preferably at 50-160° C., more preferably at 60-120° C.

The “aA” can be applied as a liquid film to the granulates, followed by the optional addition of further powdered additives, and then the extrusion takes place according to usual, known procedures.

Furthermore, it is possible to add the “aA” directly before the polymerisation/polycondensation of the monomers or the monomer mixture of the subsequent polyamide matrix, or during the polymerisation/polycondensation of the polyamide reaction mixture. During the preparation of polyamide 12, for example, the “aA” can be added to 12-aminolauric acid or lactam 12, and the resulting mixture is then polymerised, if need be, by adding at least one chain length regulator. The resulting granulate can then be thermoplastically converted in injection moulding or extrusion processes.

If there is already an application-related granulate based on (co)polyamide for which processing problems occur due to solid deposits, “aA” can be easily added in suitable amounts for application before processing, primarily as a liquid film on the granulate surface, after which, if need be, thermal post-processing can take place and compositions (D) and/or (E) thus diffuse into the granulate, which thereby regains its good flowability, or suitable solid additives can be subsequently added.

In a preferred embodiment of the invention, “aA” (D) and/or (E) is continuously incorporated into the polyamide matrix composed of (co)polyamide containing at least 20% polyamide 12 during an extrusion process, preferably by using a twin screw extruder, in particular simultaneously with the other components of the formulation. The aprotic compound can also be incorporated at higher concentrations and the granulate produced in such a way that it can be used as a master batch.

The polyamide moulding compositions according to the invention are used for thermoplastic moulding of items of practical use through discontinuous processes, in particular in injection moulding, and in continuous processes such as the (co)extrusion of films, fibres, tubes, and sheathings, the thermoplastic polyamide moulding compositions in accordance with the present invention being characterised in particular by the fact that during thermoplastic moulding no solid deposits are formed and the viscosity remains stable, i.e., approximately constant.

The present invention therefore also relates to co-extruded, hydrolysis-resistant, bursting pressure-resistant, and flexible coolant lines composed of at least one polyamide layer, the polyamides used having a surplus of amino end groups, and being produced from the polyamide moulding compositions specified in greater detail above, together with copper stabilisation and deactivator. In one particular embodiment, according to the invention multi-layer tubes are produced having at least one polyamide external layer and an internal layer composed of halogenated or non-halogenated homo- or copolyolefins, from mixtures and blends thereof, and optionally an intermediate layer composed of a material compatible with the external layer and internal layer.

Sections of the coolant lines can have continuously corrugated walls with an annular or spiral shape. In a preferred embodiment, the corrugation of the walls is broken into two approximately oppositely facing surface line areas. In one special embodiment, the intermediate layer may optionally be composed of polyolefin that is provided with functional groups and is compatible with the adjacent layers. The coolant line can be produced by coextrusion of a polymer tube and, if need be, by subsequent formation of corrugations by blow moulding or vacuum moulding, or by coextrusion blow moulding.

Polyamides with a high number of amino end groups exhibit a particularly good hydrolysis stability. As a result of this characteristic, the life span of the tubes according to the invention can be markedly improved compared to coolant lines of the prior art.

Crosslinked polyethylene exhibits an unusually high stress crack resistance against both corrosive acids and caustic solutions. Furthermore, high density polyethylene (HDPE) acts as an excellent water barrier, so that the bursting pressure-resistant external polyamide layer is well protected against the destructive effect of water by such an internal layer. The use of commercially available non-crosslinked HDPE, however, is not possible, since coolant lines must be subjected to temperatures beyond the crystalline melting point, and therefore the non-crosslinked HDPE melts at these temperatures. Crosslinkable HDPE does not have this disadvantage. A silane-crosslinked PE obtained from other systems such as peroxide- or radiation-crosslinked PE is preferable for process engineering reasons.

Polyamides with a surplus of amino end groups exhibit a significantly better and more resistant adhesion to polyolefins containing functional side groups, for instance, maleic anhydride. This adhesion is not broken even with continuing attack by heat and water.

The coolant lines according to the invention are used in the overall cooling system of automobiles, i.e. for cooling lines, heating lines, and vent lines. Depending upon the location and the task, the diameters of the lines according to the invention vary. As an example, the diameters of lines may be within the range of 5 mm to 50 mm internal diameter.

A very particularly preferred embodiment of the coolant line according to the invention comprises a polyamide 12 with surplus amino end groups as the external layer, an HDPE grafted with organosilane and crosslinked by absorption of water as the internal layer, and a compatible intermediate layer of polyolefin grafted with maleic anhydride. If grafted polypropylene is used, it has a higher melting point compared to grafted HDPE. This preferred mould according to the invention comprises corrugated as well as non-corrugated, i.e., smooth, sections.

The polymer line according to the invention can be manufactured by coextrusion of a polymer tube and if need be, by subsequent corrugation by blow moulding or vacuum moulding, Alternatively, the coolant line according to the invention can be manufactured by coextrusion blow moulding. In practice, corrugated pipes and corrugated hoses are known in various designs, and can be made of metal or plastic. Such pipes and hoses find application in the automobile industry, among others.

These processes represent prior art and are described, among other things, in DE-GM 9319190 and DE-GM 9319879.

A pressurizable coolant line according to the invention is composed of three polymer layers containing polymers that are compatible with one another, particularly at the contact surfaces of the layers, whereby the line can be corrugated in sections. The polymer line according to the invention has high flexibility and hydrolysis and bursting pressure resistance.

Another embodiment of the coolant line according to the invention manages without a bonding agent layer, and is composed of only two polymer layers. The external layer is formed from a polyamide moulding composition according to the invention. Adhering directly thereto is the internal layer made of a modified thermoplastic elastomer, for example, a mixture of EPDM and polypropylene (Santoprene® PA types, with adhesion modification).

The polymers of individual layers can be modified with processing- and use-related additives according to the prior art. Special stabilisers, softening agents, pigments, and additives for improving the impact resistance are mentioned.

The layer thicknesses of the individual layers in the embodiments according to the invention can be adapted to the requirements, for instance regarding barrier effect, bursting pressure resistance, or impact resistance, and vary between 0.05 mm and 3 mm.

In a special case of extrusion by melt spinning, the polyamide moulding compositions according to the invention may also be further processed to produce fibres.

The following examples explain the present invention without limiting same. Materials used:

Polyamide 12 according to TABLE 1

| | | |
|---|---|---|
| Relative viscosity, 0.5% in m-cresol | | 2.1 |
| MVR, 275° C./5 kg | cm³/10 min | 20 |
| Amino end groups | (μEq/g) | 55 |
| Carboxyl end groups | (μEq/g) | 10 |

### Impact Resistance Modifier (SZ Modifier) (for Example 3 Only)

Ethylene-Propylene Copolymer Grafted with Maleic Anhydride
MVR 275° C./5 kg: 13 cm³/10 min
Melting point DSC: 55° C.

### Metal Deactivator 1:

2′,3-bis[[3-[3,5-di-tert-butyl-4-hydroxyphenyl]propionyl]]propionohydrazide

### Metal Deactivator 2:

3-(Salicyloylamino)-1,2,4-triazole

The testing of the moulding compositions according to the invention and not according to the invention was carried out using the following measurement methods or specifications:

Relative viscosity: as per EN ISO 307 (0.5% in m-cresol)
COOH end groups: Titration with 0.1 M tetrabutylammonium hydroxide in benzyl alcohol
NH₂ end groups: Titration with 0.05 M ethanolic perchloric acid in m-cresol/isopropanol
MVR: (Melt volume rate) for 275° C./5 kg as per ISO 1133
SZ: Impact resistance as per ISO 179/1eU
KSZ: Notched impact strength as per ISO 179/1eA
Yield stress, elongation at tear, and elastic modulus were determined in accordance with ISO 527.

TABLE 2

| | | | | | | | Comparative |
|---|---|---|---|---|---|---|---|
| | | | Example 1 | Example 2 | Example 3 | Example 4 | example |
| Polyamide 12 (see table 1) | | Weight | 97.05 | 98.55 | 95.05 | 98.68 | 99.65 |
| | | percentage | | | | | |
| Potassium iodide | | Weight | 0.3 | 0.3 | 0.3 | 0.3 | 0.3 |
| | | percentage | | | | | |
| Copper (I) iodide | | Weight | 0.05 | 0.05 | 0.05 | 0.05 | 0.05 |
| | | percentage | | | | | |
| Metal deactivator 1 | | Weight | 0.6 | 0.6 | 0.6 | | |
| | | percentage | | | | | |
| Metal deactivator 2 | | Weight | | | | 0.22 | |
| | | percentage | | | | | |
| N-butylbenzenesulfonamide | | Weight | 2 | | 2 | | |
| | | percentage | | | | | |
| N-octylpyrrolidone | | Weight | | 0.5 | | | |
| | | percentage | | | | | |
| SZ modifier | | Weight | | | 2 | | |
| | | percentage | | | | | |
| Relative viscosity | Original | — | 2.30 | 2.31 | 2.19 | 2.22 | 2.35 |
| (0.5% .m-cresol) | | | | | | | |
| Relative viscosity | After MVR | — | 2.32 | 2.31 | 2.30 | 2.30 | 2.48 |
| (0.5% .m-cresol) | measurement, | | | | | | |
| | 4 minutes | | | | | | |
| | in the melt | | | | | | |
| Relative viscosity | After MVR | — | 2.31 | 2.29 | 2.23 | 2.34 | 2.52 |
| (0.5% .m-cresol) | measurement, | | | | | | |
| | 10 minutes | | | | | | |
| | in the melt | | | | | | |
| MVR (275° C./5 kg/4 min) | | cm³/10 min | 21 | 21 | 21 | 19 | 10.5 |
| MVR (275° C./5 kg/10 min) | | cm³/10 min | 24 | 23 | 20 | 17 | 12.3 |
| Relative viscosity | After 14 h/110° C. | | 2.17 | 2.19 | 2.11 | | 2.296 |
| (0.5% .m-cresol) | | | | | | | |
| Relative viscosity | After 24 h/110° C. | | 2.19 | 2.20 | 2.14 | | 2.354 |
| (0.5% .m-cresol) | | | | | | | |
| Relative viscosity | After 48 h/110° C. | | 2.21 | 2.23 | 2.15 | | 2.327 |
| (0.5% .m-cresol) | | | | | | | |
| MVR (275° C./5 kg/4 min) | After 14 h/110° C. | cm³/10 min | 16 | 21 | 20 | | 3.3 |
| MVR (275° C./5 kg/4 min) | After 24 h/110° C.) | cm³/10 min | 19 | 21 | 16 | | 5 |
| MVR (275° C./5 kg/4 Min) | After 48 h/110° C. | cm³/10 min | 15 | 16 | 16 | | 3.4 |
| Pinholing after 5 minutes of | | | None | None | None | None | Heavy |
| extruder standstill, at | | | | | | | |
| 250° C., for film extrusions | | | | | | | |

To test the processing stability, and especially the formation of solid deposits, corrugated pipes with a diameter of 30 mm and a wall thickness of 1.5 mm were produced from all the materials in Table 2, with the exception of material in Example 4. The pipes were produced on a commercially available single-screw extruder with a three-zone screw. The corrugated pipe geometry was produced in the vacuum process using a corrugator by Uniwell. The production of corrugated pipes in the tests of Table 3 took place over a period of 10 hours. The procedure for production of the corrugated pipes is known to those skilled in the art, for example from the literature: Walter Michaeli, Extrusionswerkzeuge für Kunststoffe and Kautschuk [Extrusion Tools for Plastics and Rubber, Carl Hanser Verlag, 2nd Ed., 1991, pp. 328, 329 and pp. 345, 346, as well as from Handbuch der Kunststoff-Extrusionstechnik [Handbook of Plastic Extrusion Technology], II, Extrusion Units, Carl Hanser Verlag, 1986, pp. 58, 59, 60.

TABLE 3
Assessment of the formation of deposits during the production of
corrugated tubes

| | | | | | | Reference |
|---|---|---|---|---|---|---|
| | | | Example 1 | Example 2 | Example 3 | example |
| Polyamide 12 (see table 1) | | Weight | 97.05 | 98.55 | 95.05 | 99.65 |
| | | percentage | | | | |
| Potassium iodide | | Weight | 0.3 | 0.3 | 0.3 | 0.3 |
| | | percentage | | | | |
| Copper (I) iodide | | Weight | 0.05 | 0.05 | 0.05 | 0.05 |
| | | percentage | | | | |
| Metal deactivator 1 | | Weight | 0.6 | 0.6 | 0.6 | |
| | | percentage | | | | |
| N-butylbenzenesulfonamide | | Weight | 2 | | 2 | |
| | | percentage | | | | |
| N-octylpyrrolidone | | Weight | | 0.5 | | |
| | | percentage | | | | |
| SZ modifier | | Weight | | | 2 | |
| | | percentage | | | | |
| Formation of coatings | Duration of the test 3 hours | | None | None | None | Heavy |
| Formation of coatings | Duration of the test 10 hours | | Slight | Slight | Slight | Heavy |
| Type of coatings | | | Flowing | Solid | Flowing | Heavy |

1. A thermoplastic polyamide moulding composition, comprising:
(A) at least 20% by wt. polyamide and/or at least one copolymer containing at least 20% by wt. polyamide structural units, wherein
the polyamide and/or the polyamide structural units are based on aliphatic C₆-C₁₂ lactams or ω-aminocarboxylic acids containing 4 to 44 carbon atoms, or are based on aromatic ω-aminocarboxylic acids containing 6 to 20 carbon atoms, or are polycondensates obtainable from the polycondensation of at least one diamine selected from the group consisting of aliphatic diamines containing 4 to 18 C atoms, cycloaliphatic diamines containing 7 to 22 C atoms in combination with at least one dicarboxylic acid selected from the group consisting of aliphatic dicarboxylic acids containing 4 to 44 C atoms, cycloaliphatic dicarboxylic acids containing 8 to 24 C atoms, and aromatic dicarboxylic acids containing 8 to 20 C atoms; and
the polyamide and/or the at least one copolymer containing at least 20% by wt. polyamide structural units have an amino end group content in the range of 25 to 300 μEq/g and a carboxyl end group content of less than 20 μEq/g, in each case relative to the polyamide portion and/or the portion of polyamide structural units;
(B) 0.01% by wt. to 2% by wt, relative to the polyamide portion and/or the portion of polyamide structural units of the composition, of a copper-containing stabiliser;
(C) 0.01% by wt. to 3% by wt., relative to the polyamide portion and/or the portion of polyamide structural units of the composition, of at least one organic compound containing metal complexing groups, selected from the group of acid amide, oxamide, oxalanilide, hydrazine, acid hydrazide, or hydrazone groups, as well as from the group of benzotriazoles, so that the copper ions are present in complexed form through binding to the metal-complexing groups; and
(D) 0.05% by wt. to a maximum 15% by wt., relative to the polyamide portion and/or the portion of polyamide structural units of the composition, of at least one compound selected from the group of softeners comprising benzenesulfonic acid alkylamides, ortho-, para-toluenesulfonic acid alkylamides, alkylhydroxybenzoates, benzenecarboxylic acid esters, phthalic acid esters, fatty acid esters, esters of polyvalent alcohols, dicarboxylic acid diesters with a carbon number of the acids of 4 to 44 atoms, trialkylmellitic acid esters, phosphoric acid esters, citric acid esters, tetraalkyl alkylenediamines, tetra(2-hydroxyalkyl)alkylenediamines, trialkylamines, and mixtures of the aforementioned compounds.

2. The thermoplastic polyamide moulding composition according to claim 1, wherein the polyamide and/or the at least one copolymer containing at least 20% by wt. polyamide structural units have an amino end group content in the range of 40 to 300 μEq/g and a carboxyl end group content of less than 15 μEq/g, in each case relative to the polyamide portion and/or the portion of polyamide structural units.

3. The thermoplastic polyamide moulding composition according to claim 1, additionally comprising:
(E) 0.05% by wt. to a maximum of 15% by wt., relative to the polyamide portion and/or the portion of polyamide structural units of the composition, of at least one aprotic compound selected from the group of N-alkylated, cyclic carboxylic acid amides containing 5-7 ring members and/or from the group of N-alkylated urea derivatives, whose alkyl residues on the nitrogen are linear or branched, and optionally contain heteroatoms and heterogroups or form a linkage of the two N atoms.

4. The thermoplastic polyamide moulding composition according to claim 1, wherein the copper-containing stabilising agent (B) comprises an alkali metal halide and at least one of a copper (I) halide, a copper (I) stearate and a copper (I) oxide, wherein a weight ratio of the alkali metal halide to the copper (I) species is 2.5:1 to 100:1.

5. The thermoplastic polyamide moulding composition according to claim 4, wherein the compound (C) containing metal-complexing groups is present in a molar ratio to the sum of the copper (I) species of 0.5:1 to 3:1, in particular the component (C) being present in at least an approximate equimolar quantity with respect to the quantity of copper of component (B).

6. The thermoplastic polyamide moulding composition according to claim 1, wherein the compound (C) comprises at least one of 2′,3-bis[[3-[3,5-di-tert-butyl-4-hydroxyphenyl]propionyl]]propionohydrazide and 2,2′-oxamido-bis[ethyl-3-(3,5-di-tert-butyl-4-hydroxyphenyl)propionate] and/or 3-(salicyloylamino)-1,2,4-triazole.

7. The thermoplastic polyamide moulding composition according to claim 1, wherein the component (A) contains at least 30% by wt. polyamide and/or at least one copolymer containing at least 30% by wt. polyamide structural units, in particular at least 40% by wt. polyamide and/or at least one copolymer containing at least 40% by wt. polyamide structural units.

8. The thermoplastic polyamide moulding composition according to claim 1, characterised in that the moulding compositions contain common additives singly or in combination which are selected from the group comprising: non-polyamide polymers, in particular polyesters, polyolefins, polycarbonates, ABS polymers, functionalised copolyolefins, ionomers and acrylonitrile; bonding agents; impact resistance modifiers; flame-proofing agents; fillers; reinforcing agents such as glass and carbon fibres (C fibres); stabilisers against degradation by light, heat or weathering; minerals; processing aids; dyes; and antistatic agents.

9. The thermoplastic polyamide moulding composition according to claim 1, further comprising nanoscale fillers.

10. The thermoplastic polyamide moulding composition according to claim 8, wherein the impact resistance modifier is selected from functionalised polyolefins that are grafted with acrylic acid or maleic anhydride.

11. The thermoplastic polyamide moulding composition according to claim 1, wherein the benzenesulfonic acid alkylamide comprises N-butylbenzenesulfonic acid amide.

12. The thermoplastic polyamide moulding composition according to claim 1, wherein the ortho-, para-toluenesulfonic acid alkylamide comprises N-butyltoluenesulfonic acid amide.

13. The thermoplastic polyamide moulding composition according to claim 1, wherein the tetra(2-hydroxyalkyl)alkylenediamine comprises N,N,N′N′-tetrakis(2-hydroxypropyl)ethylenediamine.

14. The thermoplastic polyamide moulding composition according to claim 3, wherein the cyclic carboxylic acid of the component (E) corresponds to the following formula I, x is an integer of 1 to 3, and R1 has 1 to 12 C-atoms and is linear, branched or cyclic, and also contains heteroatoms and heterogroups, in particular —O— bridges:

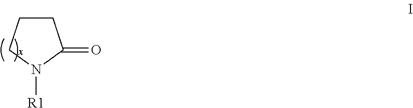

15. The thermoplastic polyamide moulding composition according to claim 3, wherein the urea derivative of the component (E) corresponds to formula II,
R′/R2-N—CO—N—R2/R′ II
where R2 and R′ are different or identical, linear or branched, and each contains 1 to 8 C-atoms, or two R′ moieties form an ethylene or propylene bridge between the two N atoms.

16. The thermoplastic polyamide moulding composition according to claim 14, wherein R1 is an octyl radical.

17. The thermoplastic polyamide moulding composition according to claim 15, wherein R2 and R′ both are butyl radicals.

18. The thermoplastic polyamide moulding composition according to claim 3, wherein as the component (E) at least one aprotic compound is used, selected from the group comprising N-isopropylpyrrolidone, N-butylpyrrolidone, N-tert-butylpyrrolidone, N-hexylpyrrolidone, N-octylpyrrolidone, N-dodecylpyrrolidone, N-cyclohexylpyrrolidone, N-2-hydroxyethylpyrrolidone, N-3-hydroxypropylpyrrolidone, N-2-methoxyethylpyrrolidone, N-3-methoxypropylpyrrolidone, N-octylcaprolactam, cyclic N,N-dimethylethylene urea, cyclic N,N-dimethylpropylene urea, and tetrabutyl urea and mixtures thereof.

19. The thermoplastic polyamide moulding composition according to claim 1, wherein the polyamide or the copolymer is essentially a polyamide selected from the group comprising:
PA 6, PA 66, PA 11, PA 12, PA 46, PA 1212, PA 1012, PA 610, PA 612, PA 69, PA 9T, PA 10T, PA 12T, PA 12I, PA 6T/12, PA 12T/12, PA 10T/12, PA 12T/106, PA 10T/106, PA 6/66, PA 6/612, PA 6/66/610, PA 6/66/12, and mixtures and copolyamides thereof;
PA 6T/66, PA 6/6T, PA 6/66/6T, PA 6/6I, PA 6T/6I, PA 6I/6T, PA 12/6T/66, PA 12/6T/6I, and mixtures and copolyamides thereof; and
PA 12/MACMI, PA 66/6I/6T, and PA MXD 6/6, and mixtures and copolyamides thereof.

20. The thermoplastic polyamide moulding composition according to claim 1, wherein the polyamide is essentially polyamide 12, in particular a hydrolytically produced polyamide 12.

21. The thermoplastic polyamide moulding composition according to claim 1, wherein the copolymer is a polyamide 12 block copolymer containing polyester, polyether, polysiloxane, polycarbonate, polyacrylate, polymethacrylate, or polyolefin segments as additional structural units, in addition to a proportion of at least 20% by wt. of polyamide 12 structural units.

22. The thermoplastic polyamide moulding composition according to claim 1, wherein the component (A) is a polyamide mixture that comprises polyamide 12 and a partially aromatic polyamide optionally containing compatibility mediators and/or impact resistance modifiers.

23. The thermoplastic polyamide moulding composition according to claim 1, wherein the component (A) comprises a polyamide mixture composed of polyamide 12 with at least one (co)polyamide selected from the group comprising:
PA 6, PA 66, PA 11, PA 46, PA 1212, PA 1012, PA 610, PA 612, PA 69, PA 9T, PA 10T, PA 12T, PA 12I, PA 6T/12, PA 12T/12, PA 10T/12, PA 12T/106, PA 10T/106, PA 6/66, PA 6/612, PA 6/66/610, PA 6/66/12, and mixtures and copolyamides thereof;
PA 6T/66, PA 6/6T, PA 6/66/6T, PA 6/6I, PA 6T/6I, PA 6I/6T, PA 16/6T/66, PA 12/6T/6I, and mixtures and copolyamides thereof; and
PA 12/MACMI, PA 66/6I/6T, and PA MXD 6/6, and mixtures and copolyamides thereof.

24. The thermoplastic polyamide moulding composition according to claim 23, wherein the polyamide mixture is present as a single- or multi-phase mixture optionally containing phase mediators and/or impact resistance modifiers.

25. The thermoplastic polyamide moulding composition according to claim 24, wherein the polyamide mixture comprises polyamide 12 and an amorphous copolyamide or polyamide.

26. A process for producing a thermoplastic polyamide moulding composition according to claim 1, comprising:
compounding the component (A), 0.01% to 3.0% by wt. of the stabiliser (B) relative to the polyamide portion and/or the portion of polyamide structural units and at least one organic compound containing metal-complexing groups as the component (C), and optionally at least one of the softening agent (D) and the aprotic compound (E), wherein the component (C) is added in at least an approximate equimolar quantity with respect to the quantity of copper in the component (B).

27. The process according to claim 26, wherein at least one of the softening agent (D) and the aprotic compound (E) is added to granulates of the (co)polyamide, and is mixed until having diffused into the granulates.

28. The process according to claim 27, wherein the process is carried out in the range of room temperature to 160° C., in particular at 60 to 120° C.

29. The process according to claim 26, wherein a least one of the softening agent (D) and the aprotic compound (E) is incorporated in a proportion of 3 to 30% by wt. into polyamide granulates corresponding to the component (A), and the granulates are then used as a master batch mould.

30. The process according to claim 26, wherein at least one of the softening agent (D) and the aprotic compound (E) is continuously incorporated into the polyamide moulding compositions during an extrusion procedure, in particular simultaneously with the other formulation components.

31. Use of the thermoplastic polyamide moulding composition according to claim 1 for thermoplastic conversion to articles in discontinuous processes including injection moulding, or in continuous processes including extrusion to produce films, tubes, fibres, and sheathings.

32. An articles comprising the moulding composition according to claim 1.

33. An extruded or co-extruded, hydrolysis-resistant, bursting pressure-resistant, and flexible coolant lines, comprising:
at least one (external) polyamide layer obtained from the polyamide moulding composition according to claim 1, optionally an internal layer containing halogenated or non-halogenated homo- or co-polyolefins from mixtures or blends of the same, optionally with bonding agent modification, or optionally containing an intermediate layer composed of a material that is compatible with the internal layer and an external layer.

34. The coolant line according to claim 33, wherein the coolant line, at least in parts, has corrugated walls having annular or spiral shapes.

35. The coolant line according to claim 34, wherein the corrugation is broken into two approximately oppositely facing surface line areas.

36. The coolant line according to claim 33, wherein the intermediate layer is composed of a polyolefin that is provided with functional groups and is compatible with the internal and external layers.

37. The coolant line according to claim 33, which is produced by coextrusion of a polymer tube, optionally followed by formation of corrugations by blow moulding or vacuum moulding or by extrusion or coextrusion blow moulding.
